(19) United States
(12) Patent Application Publication
(10) Pub. No.: US 2006/0268921 A1
(43) Pub. Date: Nov. 30, 2006

(54) Monitoring in a telecommunication network

(76) Inventors: Bo Ekstrom, Stockholm (SE); Soren Wallinder, Haninge (SE)

Correspondence Address: ERICSSON INC., 6300 LEGACY DRIVE, M/S EVR C11, PLANO, TX, 75024, US

(21) Appl. No.: 10/595,132

(22) PCT Filed: Sep. 5, 2003
(86) PCT No.: PCT/SE03/01391

§ 371 Date: Mar. 2, 2006

(51) Int. Cl. H04J 3/16

(52) U.S. Cl. 370/437

(57) ABSTRACT

The present invention relates to a method for monitoring media flow in a telecommunication network. The network comprises a control domain handling session control and a bearer domain handling media flow. The method comprises the following steps:—Storing in a database (LI-DB) in the control domain, identification of a first subscriber (A) for which monitoring is desired.—Setting up a connection between the first subscriber (A) and a second subscriber (B).—Sending an indicator (FLAG) from the control domain to the bearer domain indicating that the media flow that involves the first subscriber (A) is to be monitored.—Re-routing said media flow between the subscribers, via a server function (LI-S) in the bearer domain.—Monitoring the media flow that passes the server function (LI-S).

### TECHNICAL FIELD OF THE INVENTION

The present invention relates to methods and arrangements for monitoring media flow in a telecommunication network that comprises a control domain that handles session control and a bearer domain that handles the media flow.

### DESCRIPTION OF RELATED ART

Three major trends currently occurs in telecommunication, i.e. 1) increasing amount of data traffic, 2) real-time communication goes from circuit switching to packet switching, and 3) new focus of real-time in packet switching, for example video and multimedia. The ever increasing amount of data traffic as well as real-time communication in packet switched networks leads to a demand for monitoring of this data traffic with the same level of security and confidentiality as known from circuit switched networks monitoring. In circuit switched networks, e.g. telephony networks, it is customary to monitor communication connections from a remote operation centre so that a network operator wishing to operate real time traffic can constantly receive information on the quality of the communication lines. Another application of monitoring is lawful interception, i.e. the act of intercepting a communication on behalf of a law enforcement agency.

From the above, it is only natural that network operators will want to continue such monitoring approaches in other types of networks for example in packet switched networks.

One approach is described in the international application WO 02/102111. It is proposed to provide an interception unit to store an identification of a communication connection to be monitored. A copying unit hereby copy selected cells to a monitoring connection. The solution according to the international application implies isolation of cells to be intercepted. The content of communication has according to the international application to be intercepted in the bearer network, which network does not naturally know the identity of the intercepted target. This causes enhanced signalling in the network. There is also a technical possibility with the solution in the international application, for the end-user to find out with which IP address he is communicating, i.e. to find out that interception is going on. This possibility is often considered as a drawback.

Requirements for lawful interception in 3GPP (3^{rd} Generation Partnership Project) networks are being standardised within 3GPP and ETSI. So far requirements on IMS (IP Multimedia Subsystem) for multimedia communication are only concerned with IRI (Intercept Related Information) and not with CC (Content of Communication), i.e. the media flow. The solutions specified so far within the standardisation work foresee interception only of IRI from IMS. This is a natural consequence of the fact that CC is, for normal two-party sessions, not processed within IMS. This means that CC will have to be intercepted by involving the backbone or access network.

In a 3GPP environment an IMS subscriber is able to roam between different access lines without necessarily being a subscriber in the backbone or access networks. The identification of the target may therefore require an extensive co-ordination of information from IMS and the backbone network and access network.

### SUMMARY OF THE INVENTION

The present invention relates to problems how to handle monitoring of a media flow when session control and media flow uses different paths. In particular, problems arise when subscribers involved in the media flow move between different access networks.

The problems are solved by the invention by re-routing the session for which monitoring is desired, via a dedicated server function having a fixed location, which location is independent of change of location of subscribers involved in the media flow. The media flow that passes the dedicated server function is then monitored.

More in detail, the problem is solved by a method for monitoring media flow in a telecommunication network. The network comprises a control domain and a bearer domain. Session control is handled in the control domain and media flow is handled in the bearer domain. The method comprises the following steps:
Storing in a database in the control domain, identification of a first subscriber for which monitoring is desired.
Setting up a connection between the first subscriber and a second subscriber.
Re-routing said media flow between the subscribers, via a dedicated monitoring server function in the bearer domain.
Monitoring the media flow that passes the server function.

An arrangement according to the invention comprises means for performing the above mentioned method steps.

The object of the present invention is to make it possible to perform real-time monitoring of Content of Communication flow.

An advantage with the invention is that monitoring can be accomplished with a minimum of signalling between control- and bearer domain, also when the monitored subscriber roams between different access networks.

Another advantage is that a minimum of adaptations of the normal network functions is required.

Yet another advantage is the possibility to conceal interception to involved subscribers and to other networks.

The invention will now be described more in detail with the aid of preferred embodiments in connection with the enclosed drawings.

### BRIEF DESCRIPTION OF THE DRAWINGS

FIG. 1 belongs to prior art and discloses a block schematic illustration of two subscribers located in separate access networks. Control of the media flow is handled in a control domain and the media flow is handled in a bearer domain.

FIG. 2 shows a block schematic illustration of two subscribers, each one located in one access networks. The figure discloses interception according to the invention.

FIG. 3 shows a flow chart illustrating a method used to initiate interception according to the invention.

FIG. 4 shows a configuration where interception is hidden for involved subscribers.

FIG. 5 shows a configuration where a subscriber has moved away from its home network.

### DETAILED DESCRIPTION OF EMBODIMENTS

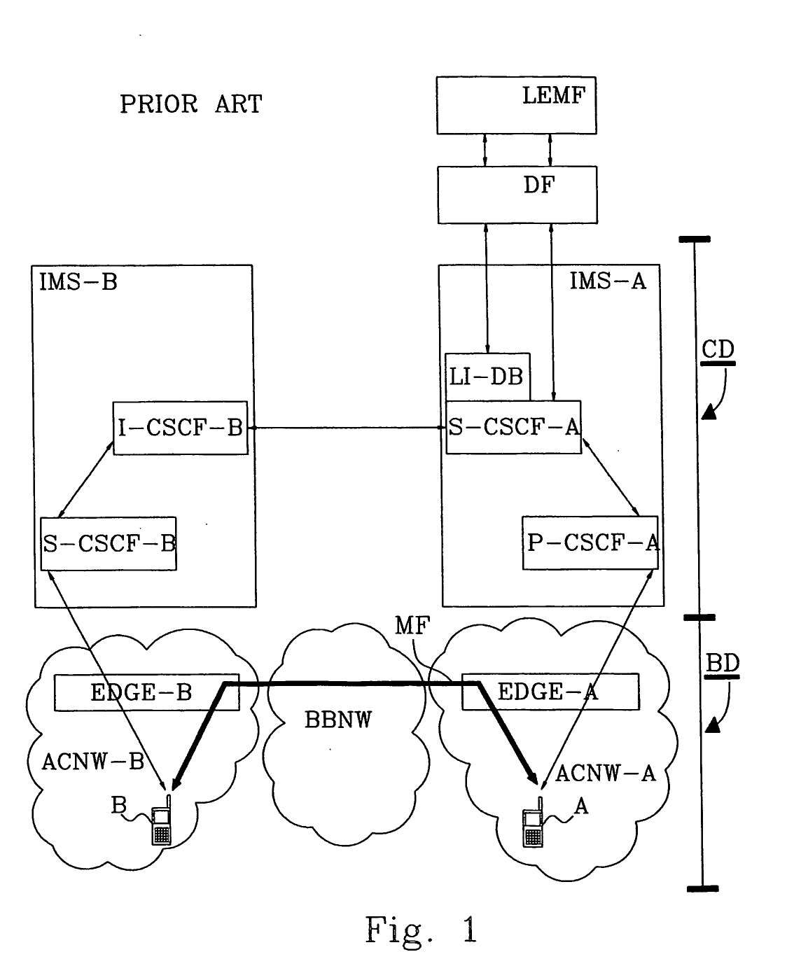

At first, interception of Intercept Related Information IRI according to current standardisation will be briefly discussed together with FIG. 1. Intercept Related Information IRI is defined as signalling information related to subscribers. FIG. 1 belongs to prior art and discloses a first mobile subscriber A and a second mobile subscriber B. The subscriber A is located in a first access network ACNW-A, which network is subscriber A's home location. Subscriber B is located in a second access network ACNW-B. Media flow MF, for example speech, is communicated between the subscribers A and B via a backbone network BBNW. The media flow is transported in a path in the bearer domain BD. The control of the media flow takes place in the control domain CD. Control information can for example be, signalling during set-up of a call. The control information related to the A subscriber is handled in the IP multimedia subsystem domain IMS-A and the control information related to the B subscriber is handled in the IP multimedia subsystem domain IMS-B. The control information passes several Call/Session Control Functions CSCF in both IMS-A and IMS-B. Requirements for interception of control information, also called Intercept related information IRI, are being standardised within the 3GPP and ETSI. FIG. 1 discloses interception of IRI according to prior art. The control information is hereby copied into a lawful interception database LI-DB located in relation to a serving CSCF in IMS-A, i.e. S-CSCF-A. The information is then forwarded from the LI-DB to a lawful interception monitoring facility LEMF, where the IRI is monitored. Information that is of interest to monitor can for example be if a certain subscriber has made a call, to whom the call was made and for how long time. After a call has been set-up between the subscriber A and B, the media flow MF between the subscribers is routed via an edge-node EDGE-A in the access network ACNW-A, the backbone network BBNW and via an edge-node EDGE-B in the access network ACNW-B.

According to the present invention, which now will be discussed, it is the content of communication that is of particular interest to monitor, i.e. the media flow MF in the bearer domain BD.

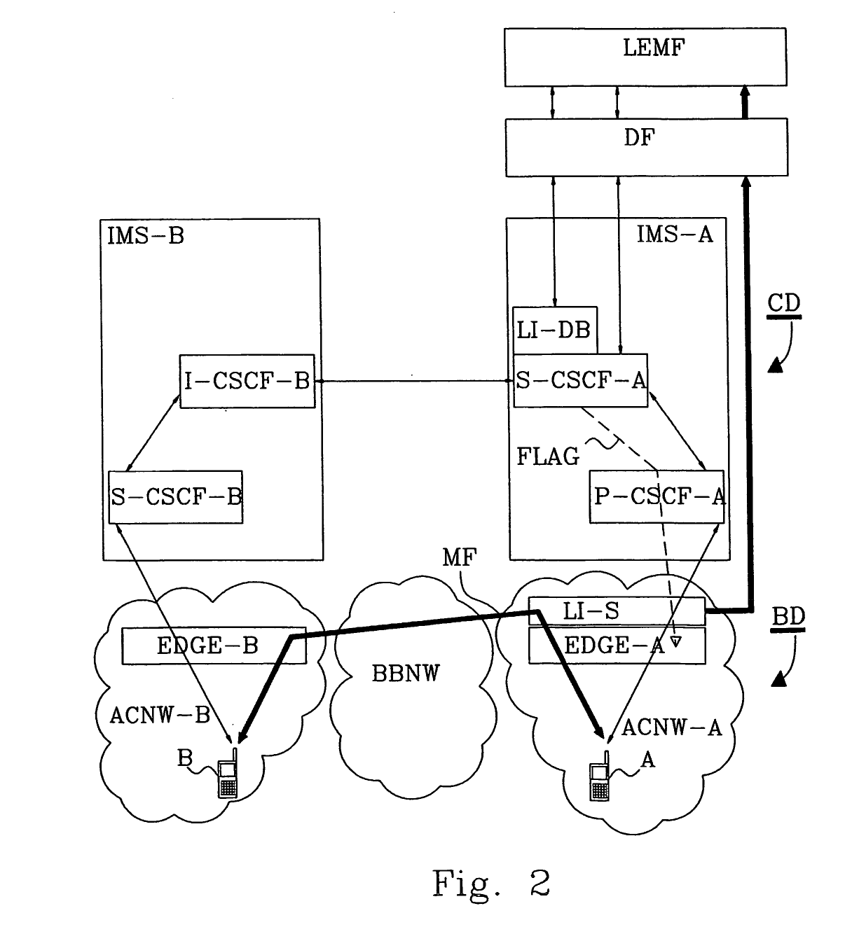

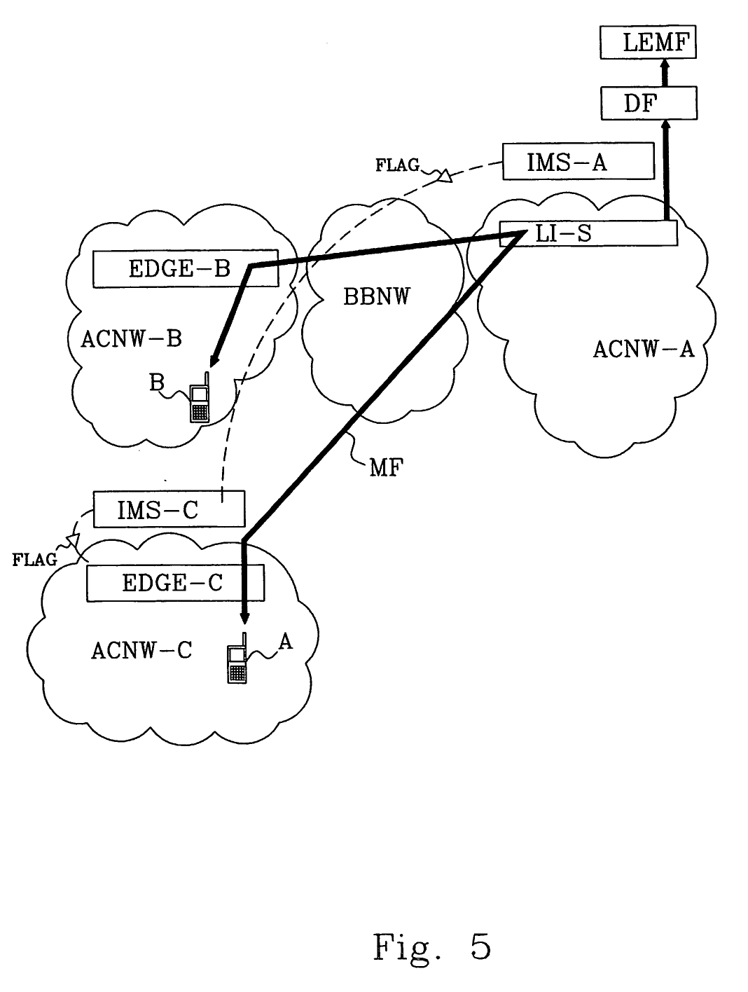

FIG. 2 discloses interception according to the invention. The figure shows the same network as was disclosed in FIG. 1. A database, for example the lawful interception database LI-DB contains identification of what subscribers that are to be monitored. In this first embodiment, the first subscriber A is to be monitored and consequently an identification of A is stored in LI-DB. When a call is set-up between the subscriber A and the subscriber B, monitoring according to the invention takes place. The call set-up in this example involves the two IP multimedia domains IMS-A and IMS-B whereby control signalling is transferred between the domains. According to the invention an indicator FLAG is sent in connection with a call set-up involving the selected subscriber A, from the serving control function S-CSCF-A, via an interrogating control function P-CSCF-A to the access network ACNW-A. The FLAG is forwarded to the edge node EDGE-A in ACNW-A. When the indicator FLAG is received by EDGE-A in the access network ACNW-A a further node function i.e. a dedicated so-called lawful interception server function LI-S is initiated in ACNW-A. The LI-S is initiated by using an address that is predefined in EDGE-A to be used for re-routing of media flow via LI-S after arrival of the indicator FLAG. The media flow between the subscribers A and B is now re-routed to go via the lawful interception server function LI-S, compare FIG. 1. LI-S initiates a 3-part “conference” between A and B (the two original users) and a third user i.e. a Distribution Function DF. The distribution function is only a listener and is not to be recognised by A and B. Even if subscriber A should move from ACNW-A to another network, the media flow would still be routed via LI-S. The signalling in the control domain CD will by this be minimised. This can be seen in a third embodiment together with FIG. 5. During the whole media flow session, the DF forwards all the content flowing in both directions between A and B, from LI-S to a Lawful interception Enforcement Monitoring Function LEMF. As an alternative, the indicator FLAG might contain an adjusted IP address, which is used by the edge node to address LI-S. In this case no address to LI-S has to be predefined in the edge node. It is also to be noted that the location of LI-S is an example and that LI-S as well might be initiated somewhere else, for example in the backbone network BBNW. The server function LI-S does not have to be located in a physically separated server function.

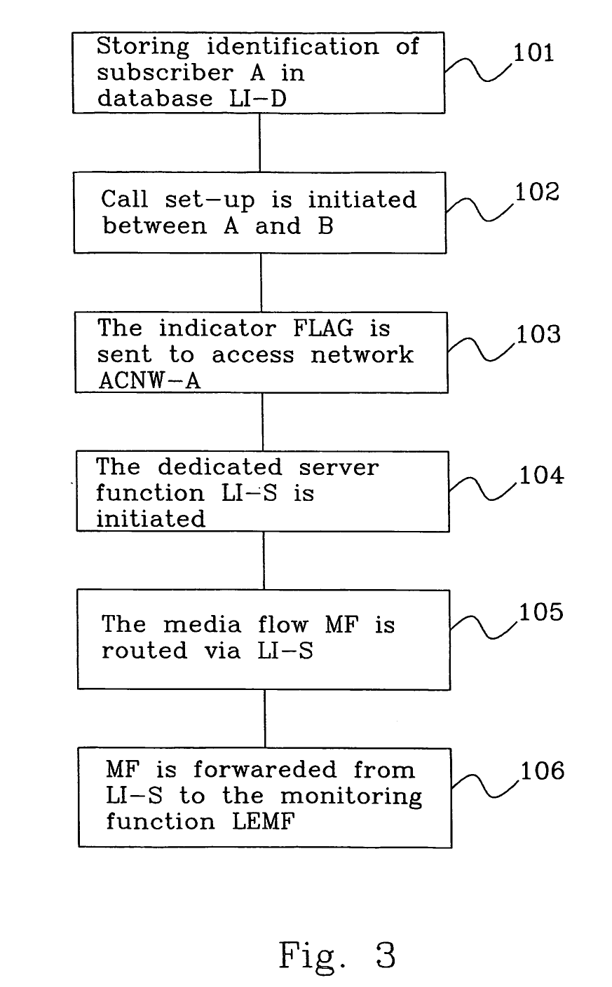

In FIG. 3 some essential steps of the invention is disclosed in a flowchart. The flowchart is to be read together with the earlier shown FIG. 2. The method according to the invention comprises the following steps:
Storing in the lawful interception database LI-DB, identification of the first subscriber A, which is to be intercepted. This step is shown in FIG. 3 by a block 101.
A call set-up between the first subscriber A and the second subscriber B is initiated. A block 102 shows this step.
The indicator FLAG is sent from the IP multimedia subsystem IMS-A to the access network ACNW-A. A block 103 shows this step.
A dedicated lawful interception server function LI-S is initiated in ACNW-A. A block 104 shows this step.
The media flow MF is routed between the subscribers A and B via the lawful interception server function LI-S. A block 105 shows this step.
The media flow is forwarded from LI-S to the Lawful Interception Monitoring Function LEMF where the MF is monitored. A block 106 shows this step.

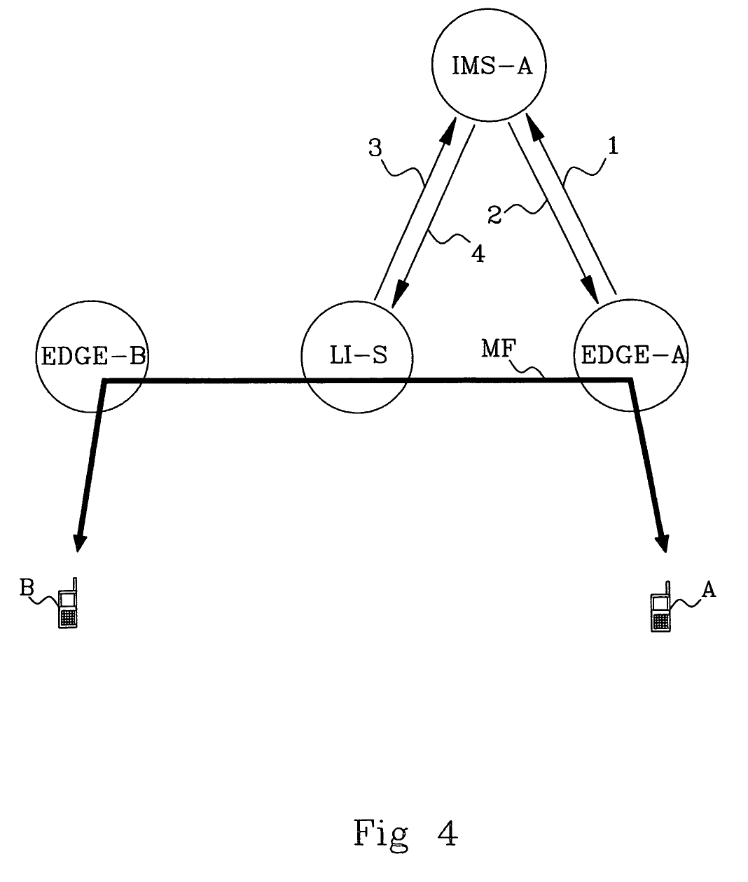

A second embodiment is disclosed in FIG. 4. FIG. 4 shows parts of the network that has been disclosed in FIG. 2. The media flow MF is like in the earlier embodiments communicated between the first subscriber A and the second subscriber B. The media flow is hereby communicated via the edge-node EDGE-A in the access network ACNW-A, the lawful interception server function LI-S in ACNW-A and via the edge-node EDGE-B in the access network ACNW-B. In order to hide the interception to involved subscribers, a different addressing scheme has been implemented in this embodiment. In this embodiment, the inherent notification of the LI-S address is unknown by the edge node during the whole monitoring session. The different addressing scheme is set-up after reception of the notification to EDGE-A, that subscriber A is to be intercepted. The media flow is re-routed via the lawful interception server function LI-S, but in this second embodiment the routing will be hidden. The edge-node is hereby unaware of the lawful interception server function LI-S and the subscriber A can not reach information about LI-S from the edge-node. When a data packet arrives from the subscriber A to the edge node, instead of forwarding the packet to LI-S (unknown to EDGE-A), the edge-node will send a request message 1 to the IP multimedia subsystem domain IMS-A asking for an address to subscriber B to forward the packet to. The IMS-A replies to EDGE-A by sending a reply message 2 with an address to LI-S, and EDGE-A uses this address to forward the packet to LI-S. In the same way when LI-S is to send the packet arrived from the edge node, the LI-S send a request message 3 to the IP multimedia subsystem domain IMS-A asking for an address to forward the packet to. The IMS-A replies to EDGE-A by sending a reply message 4 with an address to the second subscriber B.

The already mentioned third embodiment is disclosed in FIG. 5. The first subscriber A has, like in the earlier two embodiments, its home location in the first access networks ACNW-A. In this third embodiment however, the subscriber A has moved temporarily to another network ACNW-C. ACNW-C comprises an edge node EDGE-C. The IP multimedia subsystem domain IMS-A will be involved in the session initiation between subscriber A and another subscriber, subscriber B in this case. The indicator FLAG will in this case be sent from IMS-A to ACNW-C via an IP multimedia subsystem IMS-C. The indicator FLAG contains in this case an adjusted IP address, which is used by the edge node EDGE-C to address LI-S. The media flow MF between A and B will then be routed via the lawful interception server function LI-S which is located in ACNW-A. This means that data packets in the media flow MF from subscriber A will be sent from the edge node EDGE-C, via LI-S in ACNW-A, to EDGE-B. Data packets in the media flow from subscriber B will be sent from EDGE-B, via LI-S in ACNW-A, to EDGE-C. The media flow between the subscribers A and B is now routed to go via the lawful interception server function LI-S. LI-S initiates a 3-part “conference” between A and B (the two original users) and the Distribution Function DF. The distribution function is only a listener and is not to be recognised by A and B.

Different variations are of course possible within the scope of the invention. The lawful interception server function LI-S can for example be located in the backbone network BBNW or within the edge node EDGE-A. The two subscribers A and B can be situated in the same access network or in different access networks in different countries. In the embodiments, the subscriber A is the monitored subscriber and if using standard telecommunication terminology it can be assumed that the subscriber A also is the calling subscriber while subscriber B is the called subscriber. It is to be noted that the claimed invention also covers cases when the monitored subscriber is the called subscriber. Also conference calls involving more than two parties is covered by the claimed invention and of course also when more than one subscriber in the conference is monitored. The subscriber unit for which interception is desired may have roamed to an access network in another country than the country of the subscribers home access network. It is important to observe that interception only is one type of monitoring for which the invention is applicable. Other types of monitoring might for example be monitoring of the type of media flow or quality measurements monitoring. The flag indicator is in the example sent during the call set-up session but can of course also be sent after the call set-up has finished in which case the media flow is re-routed via the lawful interception server function.

The invention is not limited to the above described and in the drawings shown embodiments but can be modified within the scope of the enclosed claims.

1-11. (canceled)

12. A method for monitoring media flow in a telecommunication network having a control domain for handling session control and a bearer domain for handling media flow, comprising the steps of:
storing, in a database in the control domain, identification of a first subscriber for which monitoring is desired;
setting up a connection between the first subscriber and a second subscriber;
re-routing said media flow between the subscribers, via a dedicated server function in the bearer domain; and,
monitoring the media flow that passes the server function.

13. The method for monitoring media flow in a telecommunication network according to claim 12, further comprising the step of sending an indicator from the control domain to the bearer domain indicating that the media flow that involves the first subscriber is to be monitored.

14. The method for monitoring media flow in a telecommunication network according to claim 13, further comprising the step of sending an address to the server function from the control domain to the bearer domain.

15. A method for monitoring media flow in a telecommunication network having a control domain and a bearer domain, wherein session control is handled in the control domain and media flow is handled in the bearer domain, comprising the steps of:
re-routing of a media flow session for which monitoring is desired, via a fixed location, which location is independent by change of location of subscribers involved in the media flow; and,
monitoring of the media flow when it passes the fixed location.

16. The method for monitoring media flow in a telecommunication network according to claim 15, further comprising the steps of:
storing, in a database in the control domain, identification of a first subscriber for which monitoring is desired,
setting up a connection between the first subscriber and a second subscriber; and,
routing said media flow between the first and second subscribers via the fixed location in the bearer domain.

17. The method for monitoring media flow in a telecommunication network according to claim 15, further comprising the step of sending an indicator from the control domain to the bearer domain indicating that the media flow that involves the first subscriber is to be monitored.

18. The method for monitoring media flow in a telecommunication network according to claim 15, further comprising the step of setting up a three-part conference between the first and second subscribers and a monitoring function, which monitoring function is a listener only function.

19. The method for monitoring media flow in a telecommunication network according to claims 15, further comprising the step of exchanging an address to the dedicated server function with a pseudo address in order to hide the routing of the media flow via the server function for the first and second subscribers.

20. A system to monitor media flow in a telecommunication network having a control domain for handling session control and a bearer domain for handling media flow, comprising:
means for storing, in a database in the control domain, identification of a first subscriber for which monitoring is desired;
means for setting up a connection between the first subscriber and a second subscriber;
means for sending an indicator from the control domain to the bearer domain indicating that the media flow that involves the first subscriber is to be monitored:
means for re-routing said media flow between the subscribers via a server function in the bearer domain; and,
means for monitoring the media flow that passes the server function.

21. The system to monitor media flow in a telecommunication network according to claim 20, further comprising means for setting up a three-part conference between the first and second subscribers and a distribution function, wherein the distribution function is a listener only function.

22. The system to monitor media flow in a telecommunication network according to claim 20, further comprising means for exchanging an address to the dedicated server function with a pseudo address in order to hide the routing of the media flow via the server function for the first and second subscribers.
